(19) United States
(12) Patent Application Publication
(10) Pub. No.: US 2024/0428536 A1
(43) Pub. Date: Dec. 26, 2024

(54) DEVICE, METHOD AND PROGRAM FOR CONVERTING COORDINATES OF 3D POINT CLOUD

(71) Applicant: NIPPON TELEGRAPH AND TELEPHONE CORPORATION, Tokyo (JP)

(72) Inventors: Yusuke SAKURAHARA, Musashino-shi, Tokyo (JP); Masaaki INOUE, Musashino-shi, Tokyo (JP); Tomoya SHIMIZU, Musashino-shi, Tokyo (JP); Nazuki HONDA, Musashino-shi, Tokyo (JP)

(73) Assignee: NIPPON TELEGRAPH AND TELEPHONE CORPORATION, Tokyo (JP)

(21) Appl. No.: 18/274,119

(22) PCT Filed: Feb. 5, 2021
(86) PCT No.: PCT/JP2021/004279

§ 371 Date: Jul. 25, 2023

(51) Int. Cl. G06T 19/20

(52) U.S. Cl. CPC G06T 19/20; G06T 2219/2016

(57) ABSTRACT

An object of the present disclosure is to enable superimposition of point cloud data in relative coordinates acquired by a three-dimensional laser scanner on point cloud data in absolute coordinates, even when errors occur in the distance measurement by the three-dimensional laser scanner. The present disclosure is a three-dimensional point cloud coordinate conversion device configured to acquire first and second point cloud data of relative coordinates centered at first and second origins and absolute coordinates of the first and second origins, specify reference points of an object to be measured included in the first and second point cloud data respectively, specify a contact point between circles having distances from the first origin and the second origin to the reference points as their radii, by changing at least either the first distance or the second distance, specify a rotation angle for converting the first and second point cloud data into absolute coordinates on the basis of the three points, i.e., the contact point, the first or second origin, and the reference points of the object to be measured, and rotate the first and second point cloud data.

### TECHNICAL FIELD

The present disclosure relates to a coordinate conversion, a coordinate conversion method, and a coordinate conversion program for converting a three-dimensional point cloud.

### BACKGROUND ART

Communication services by electric signals and optical signals are provided by being connected to each other from a communication station to a building or a customer's house by physical equipment. Maintenance and management of facilities are essential to provide safe, secure, and stable services, and so far, an on-site worker has been visiting the site to visually check and inspect the condition of each piece of equipment individually. In recent years, the technology for determining the deterioration of utility poles using an MMS (Mobile Mapping System) has been developed, and efficient diagnosis of utility pole equipment has been realized (NPL 1). This technology involves mounting a three-dimensional laser scanner (three-dimensional laser surveying machine), a front camera, an omnidirectional camera, a GPS (Global Positioning System) receiver, an IMU (Inertial Measurement Unit), and an odometer (travel distance meter) in an inspection vehicle to perform three-dimensional laser scanning and image photographing during traveling of the inspection vehicle, thereby performing three-dimensional survey of a structure in a planar manner to acquire three-dimensional point cloud data having reflection intensity and absolute coordinates. The MMS is an effective means for acquiring three-dimensional point cloud data in diagnosing a plurality of utility poles along a road at once.

On the other hand, there is a fixed three-dimensional laser scanner as a means for acquiring three-dimensional point cloud data at a spot such as when the object to be measured is a single utility pole. A fixing base such as a tripod is fixed to the ground surface, and the three-dimensional laser scanner is installed on the fixing base to perform measurement. The three-dimensional laser scanner performs three-dimensional surveying of a structure by emitting a laser beam while rotating in both horizontal and vertical directions relative to the ground surface between 0° to 360°, to acquire three-dimensional point cloud data having reflection intensity and relative coordinates. The three-dimensional point cloud data are constituted of relative coordinates centered at the origin. In order to superimpose the acquired three-dimensional point cloud data on data acquired in absolute coordinates such as the MMS, it is necessary to convert the three-dimensional point cloud data acquired in relative coordinates into absolute coordinates.

### CITATION LIST

### Non Patent Literature

[NPL 1] M. Inoue, 3D modeling of communication cables from a laser point cloud using a rule-based approach and machine learning, IWCS 2019.10.

### SUMMARY OF INVENTION

### Technical Problem

Conversion from three-dimensional point cloud data in relative coordinates to three-dimensional point cloud data in absolute coordinates may be performed by measuring the three-dimensional laser scanner including the object to be measured at two measurement points, finding the points of contact of a circle having the distance from the measurement points to the object to be measured as its radius, and rotating the relative coordinates to match the absolute coordinates of the points of contact. However, when an error occurs in measuring the distance from the three-dimensional laser scanner to the utility pole, which is the object to be measured, a single contact point cannot be obtained, and the point cloud of relative coordinates cannot be converted to absolute coordinates.

Therefore, an object of the present disclosure is to enable superimposition of point cloud data in relative coordinates acquired by a three-dimensional laser scanner on point cloud data in absolute coordinates, even when errors occur in the distance measurement by the three-dimensional laser scanner.

### Solution to Problem

The present disclosure performs three-dimensional laser scanner measurement including an object to be measured at two measurement points on a straight line passing through the object to be measured, obtains circles having the distance from the measurement points to the object to be measured as their radii respectively, and identifies the contact points of the obtained two circles by correcting the radius of at least one of the circles if the two circles are not tangent at a single point.

A coordinate conversion device and a coordinate conversion method of the present disclosure:
acquire first point cloud data in which an object to be measured existing in a three-dimensional space is represented by a point cloud of relative coordinates centered at a predetermined first origin, and absolute coordinates of the first origin, convert coordinates of the first point cloud data into relative coordinates having the absolute coordinates of the first origin as an origin,
acquire second point cloud data represented by a point cloud of relative coordinates centered at a second origin located on a straight line connecting the object to be measured and the first origin, and absolute coordinates of the second origin, convert coordinates of the second point cloud data into relative coordinates having the absolute coordinates of the second origin as an origin,
specify a first reference point of the object to be measured in relative coordinates having absolute coordinates of the first origin as an origin, by using the first point cloud data,
specify a second reference point of the object to be measured in relative coordinates having absolute coordinates of the second origin as an origin, by using the second point cloud data,
calculate a first distance between the first origin and the first reference point and a second distance between the second origin and the second reference point,
specify a contact point between a first circle having the first origin as a center and the first distance as a radius and a second circle having the second origin as a center and the second distance as a radius, by changing at least one of the first and second distances, and
specify a rotation angle for converting the first or second point cloud data into absolute coordinates on the basis of the contact point, the first origin or the second origin, and the first or second reference point, rotate the first point cloud data or the second point cloud data, and convert the first point cloud data or the second point cloud data into a point cloud of absolute coordinates.

Specifically, a coordinate conversion program according to the present disclosure is a program for causing a computer to realize functional units of the device according to the present disclosure, and is a program for causing a computer to execute steps of a communication method executed by the device according to the present disclosure.

### Advantageous Effects of Invention

According to the present disclosure, superimposition of point cloud data in relative coordinates acquired by a three-dimensional laser scanner on point cloud data in absolute coordinates is made possible, even when errors occur in the distance measurement by the three-dimensional laser scanner.

### BRIEF DESCRIPTION OF DRAWINGS

FIG. 1 is an example of a system configuration of the present disclosure.

FIG. 2 is a block configuration diagram of a coordinate conversion device.

FIG. 3 is a diagram for explaining the derivation of coordinates of an intersection point and a contact point by showing three conditions: typical two circles have an intersection point, they have a contact point, and they have no intersection points.

FIG. 4 is a diagram for explaining the calculation of a theoretical measured object center absolute coordinate from two circles having the distance between an origin and an object to be measured as their radii, by extracting the distance to the object to be measured from a point cloud of the object to be measured included in a point cloud obtained from two origins with different distances on an ideal straight line.

FIG. 5A is a diagram for also explaining the calculation of a measured object center absolute coordinate by extracting the distance to the object to be measured from a point cloud of the object to be measured included in a point cloud obtained from two origins with different distances on a straight line, adjusting parameters calculated by the measurement when two circles whose radii are the distances between the origins and the object to be measured intersect and have two intersection points, and then finding the contact points.

FIG. 5B is a diagram for also explaining the calculation of a measured object center absolute coordinate by extracting the distance to the object to be measured from a point cloud of the object to be measured included in a point cloud obtained from two origins with different distances on a straight line, adjusting parameters calculated by the measurement when two circles whose radii are the distances between the origins and the object to be measured intersect and have two intersection points, and then finding the contact points.

FIG. 6A is a diagram for also explaining the calculation of a measured object center absolute coordinate by extracting the distance to the object to be measured from a point cloud of the object to be measured included in a point cloud obtained from two origins with different distances on a straight line, adjusting parameters calculated by the measurement when two circles whose radii are the distances between the origins and the object to be measured do not intersect and therefore have no intersection points, and then finding a contact point.

FIG. 6B is a diagram for also explaining the calculation of a measured object center absolute coordinate by extracting the distance to the object to be measured from a point cloud of the object to be measured included in a point cloud obtained from two origins with different distances on a straight line, adjusting parameters calculated by the measurement when two circles whose radii are the distances between the origins and the object to be measured do not intersect and therefore have no intersection points, and then finding a contact point.

FIG. 7 is a diagram for explaining the calculation of a measured object center absolute coordinate by extracting the distance to a measurement object from the point cloud of the object to be measured that is included in a point cloud obtained from two origins with different distances on a straight line, and adjusting the value of the distances between the origins and the object to be measured by using the distances between the origins and the object to be measured and the distances between the two origin coordinates.

FIG. 8 is a diagram for explaining the calculation of a measured object center absolute coordinate by extracting the distance to a measurement object from a point cloud of the object to be measured that is included in the point cloud obtained from two origins with different distances on a straight line, and adjusting the value of the distances between the origins and the object to be measured by using the distance between x and y coordinates of intersection points of two circles whose radii are the distances between the origins and the object to be measured.

FIG. 9 is a diagram for explaining the calculation of a measured object center absolute coordinate by extracting the distance to a measurement object from a point cloud of the object to be measured that is included in the point cloud obtained from two origins with different distances on a straight line, and adjusting the value of the distances between the origins and the object to be measured by using the distance between the intersection points of two circles whose radii are the distances between the origins and the object to be measured.

### DESCRIPTION OF EMBODIMENTS

Embodiments of the present disclosure will be described in detail below with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

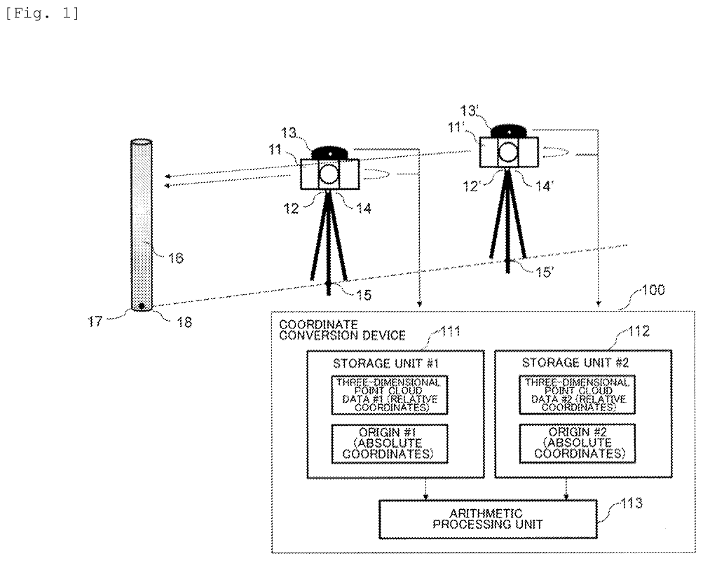

Embodiments of the present disclosure will be described below. FIG. 1 shows an example of a system configuration of the present disclosure. The system of the present disclosure includes a coordinate conversion device 100 for converting point cloud data of relative coordinates acquired by using a fixed three-dimensional laser scanner into absolute coordinates. Here, 11 is a three-dimensional laser scanner fixed to a tripod, 12 is a relative coordinate origin of 11, 13 is a GNSS (Global Navigation Satellite System) surveying instrument, 14 is an absolute coordinate origin of 11, 15 is a first measurement position, 11′ is a three-dimensional laser scanner fixed to a tripod, 12′ is a relative coordinate origin of 11′, 13′ is a GNSS surveying instrument, 14′ is an absolute coordinate origin of 11, 15′ is a second measurement position, 16 is an object to be measured, 17 is a relative center coordinates of the object to be measured, 18 is an absolute center coordinate of the object to be measured, and 111 and 112 are storage units.

The system of the present disclosure performs measurement by a three-dimensional laser scanner at two measurement points on a straight line passing through an object to be measured 16, including, as the measurement range, the object to be measured 16 that is to be digitized as three-dimensional point cloud data. Here, the object to be measured 16 is an arbitrary structure used in a communication system, such as a utility pole. The three-dimensional laser scanner 11 is a three-dimensional laser surveying machine, and acquires point cloud data in which the object to be measured 16 existing in a three-dimensional space is represented by a point cloud. When the three-dimensional laser scanner 11 rotates in a horizontal direction, point cloud data of relative coordinates with the installation position of the three-dimensional laser scanner 11 as an origin is acquired.

In the present embodiment, the three-dimensional laser scanner 11 fixed to a tripod acquires point cloud data of relative coordinates with the relative coordinate origin 12 as an origin at the first measurement position 15, and stores the point cloud data in the storage unit 111. The three-dimensional laser scanner 11′ fixed to a tripod acquires point cloud data of relative coordinates with a relative coordinate origin 12′ as an origin at the second measurement position 15′, and stores the point cloud data in the storage unit 112. The relative coordinate origins 12 and 12′ are positioned on the straight line passing through the object to be measured 16. The point cloud data of the relative coordinates acquired at the first measurement position 15 is referred to as first point cloud data. The point cloud data of the relative coordinates acquired at the second measurement position 15′ is referred to as second point cloud data.

The system of the present disclosure measures absolute coordinates of the origins of point cloud data acquired at the two measurement points. For example, at the first measurement position 15, the GNSS surveying instrument 13 measures the origin absolute coordinate 14 of the three-dimensional laser scanner 11 and stores it in a storage unit 111. At the second measurement position 15′, the GNSS surveying instrument 13 measures the origin absolute coordinate 14′ of the three-dimensional laser scanner 11′ and stores it in the storage unit 112. The origin absolute coordinate 14 measured at the first measurement position 15 is referred to as a first origin. The origin absolute coordinate 14′ measured at the second measurement position 15′ is referred to as a second origin.

The coordinate conversion device 100 includes the storage units 111 and 112 and an arithmetic processing unit 113. The storage unit 111 stores point cloud data (relative coordinates) acquired by the three-dimensional laser scanner 11 and the origin absolute coordinate 14. The storage unit 112 stores point cloud data (relative coordinates) acquired by the three-dimensional laser scanner 11′ and the origin absolute coordinate 14′.

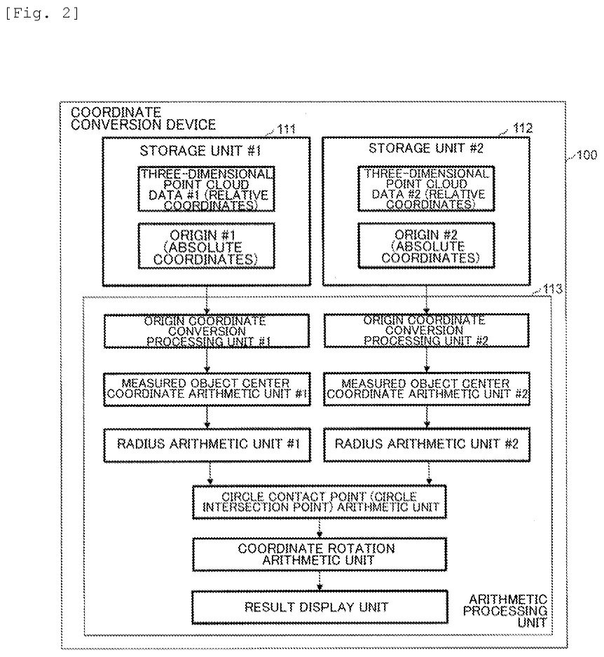

FIG. 2 shows an example of a block configuration diagram of the coordinate conversion device 100. The arithmetic processing unit 113 performs arithmetic operations in an origin coordinate conversion processing unit #1, a measured object center coordinate arithmetic unit #1, and a radius arithmetic unit #1 from the relative coordinate origin 12 measured by using the three-dimensional laser scanner 11 and the origin absolute coordinate 14 measured by using the GNSS surveying instrument 13. The arithmetic processing unit 113 performs arithmetic operations in an origin coordinate conversion processing unit #2, a measured object center coordinate arithmetic unit #2, and a radius arithmetic unit #2 from the relative coordinate origin 12′ measured by using the three-dimensional laser scanner 11′ and the origin absolute coordinate 14′ measured by using the GNSS surveying instrument 13′. Thereafter, the arithmetic processing unit 113 superimposes the point cloud data acquired by the three-dimensional laser scanner and the point cloud data acquired by the MMS by the arithmetic operation of a circle contact (circle intersection) arithmetic unit and a coordinate rotation arithmetic unit, and outputs a result at a result display unit.

The coordinate conversion device 100 can also be implemented by a computer and a program, and the program can be recorded on a recording medium or provided through a network.

The origin coordinate conversion processing unit #1 converts the coordinates of the first point cloud data into relative coordinates having the absolute coordinates of the first origin at the origin. Specifically, the whole point cloud of the first point cloud data is moved in parallel so that the origin absolute coordinate 14 is the center, and the origin coordinate is converted. Here, the first point cloud data after the origin coordinate conversion indicates the same coordinate information as the origin absolute coordinate 14. The measured object center coordinate arithmetic unit #1 specifies absolute coordinates of the center of the object to be measured 16, which is a first reference point, on the basis of the first point cloud data subjected to coordinate conversion. Here, although the present embodiment describes an example in which the reference point of the object to be measured 16 is the center of the object to be measured 16, but the reference point of the object to be measured 16 is not limited to the center of the object to be measured 16; the reference point can be an arbitrary reference point capable of specifying the position of the object to be measured 16, such as a point on the circumference of the object to be measured 16.

The radius arithmetic unit #1 calculates the distance between the origin absolute coordinate 14 and the absolute coordinate of the center of the object to be measured 16. This distance is referred to as a first distance.

The origin coordinate conversion processing unit #2, the measured object center coordinate arithmetic unit #2, and the radius arithmetic unit #2 are configured to execute the same processing as that of the origin coordinate conversion processing unit #1, the measured object center coordinate arithmetic unit #1, and the radius arithmetic unit #1. Thus obtained absolute coordinate of the center of the object to be measured 16 is a second reference point, and the distance between the origin absolute coordinate 14′ and the absolute coordinate of the center of the object to be measured 16 is referred to as a second distance.

The circle contact point (circle intersection) arithmetic unit specifies the contact point between a first circle centered at the origin absolute coordinate 14 and having the first distance as its radius, and a second circle centered at the origin absolute coordinate 14′ and having the second distance as its radius. When no error occurs in the distance measurement by the three-dimensional laser scanner, these two circles are in contact with each other. However, if an error occurs in the distance measurement by the three-dimensional laser scanner, these two circles have two intersection points, or the two circles have no intersection points. In such a case, a circle contact (circle intersection) arithmetic unit corrects at least one of the first distance and the second distance, and specifies a contact point of the two circles.

The coordinate rotation arithmetic unit specifies a rotation angle for converting the first or second point cloud data into absolute coordinates on the basis of three points, i.e., the absolute coordinate of the specified contact point or intersection point, the origin absolute coordinate 14 or 14′, and the absolute coordinate of the center of the object to be measured 16 or 16′, to rotate the first point cloud data and the second point cloud data.

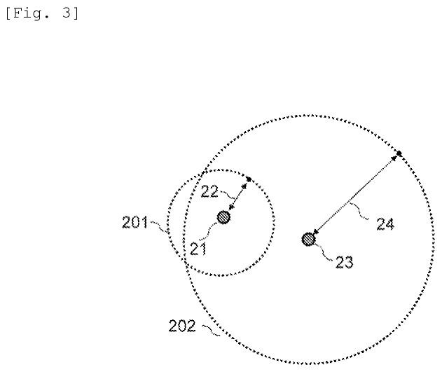

FIG. 3 is a diagram for explaining the derivation of coordinates of an intersection point and a contact point by showing three conditions: typical two circles have an intersection point, they have a contact point, and they have no intersection points. A circle 201 is a circle having a center coordinate 21 (p₁, q₁) and a radius 22 (s), a circle 202 is a circle having a center coordinate 23 (p₂, q₂) and radius 24(t). These two circles are represented by the following expression.

$$[ Math . 1 ]$$

$${( x - {p}_{1} )}^{2} + {( y - {q}_{1} )}^{2} = {s}^{2} \qquad ( 1 )$$

$${( x - {p}_{2} )}^{2} + {( y - {q}_{2} )}^{2} = {t}^{2} \qquad ( 2 )$$

These two expressions, when taken as simultaneous expressions, yield the following expression.

$$[ Math . 3 ]$$

$$( {p}_{1} - {p}_{2} ) x + ( {q}_{1} - {q}_{2} ) y - \frac{{p}_{1}^{2} - {p}_{2}^{2} + {q}_{1}^{2} - {q}_{2}^{2} - {s}^{2} + {t}^{2}}{2} = 0 \qquad ( 3 )$$

This expression represents an expression of a straight line passing through the intersection point.

Here,

$$[ Math . 4 ]$$

$$P = {p}_{1} - {p}_{2} \qquad ( 4 )$$

$$Q = {q}_{1} - {q}_{2} \qquad ( 5 )$$

$$A = \frac{{p}_{1}^{2} - {p}_{2}^{2} + {q}_{1}^{2} - {q}_{2}^{2} - {s}^{2} + {t}^{2}}{2} \qquad ( 6 )$$

The expression (3) is represented by the following expression.

$$[ Math . 7 ]$$

$$Px + Qy - A = 0 \qquad ( 7 )$$

By substituting this expression (7) into the expression (1), a quadratic expression for x and a quadratic expression for y are obtained.

$$[ Math . 8 ]$$

$$( {P}^{2} + {Q}^{2} ) {x}^{2} - 2 ( {Q}^{2} {p}_{1} + PA - {PQq}_{1} ) x + {Q}^{2} {p}_{1}^{2} + {A}^{2} + {Q}^{2} {q}_{1}^{2} - 2 {Qq}_{1} A - {Q}^{2} {s}^{2} = 0 \qquad ( 8 )$$

$$( {P}^{2} + {Q}^{2} ) {y}^{2} - 2 ( {P}^{2} {q}_{1} + QA - {PQp}_{1} ) y + {P}^{2} {q}_{1}^{2} + {A}^{2} + {P}^{2} {p}_{1}^{2} - 2 {Pp}_{1} A - {P}^{2} {s}^{2} = 0 \qquad ( 9 )$$

is obtained. The solutions of these two expressions are the x-coordinates and y-coordinates of the intersection and contact points.

From the expression (8), a discriminant D is expressed as follows.

$$\begin{matrix}[ Math . 10 ] & \\ D = {( {Q}^{2} {p}_{1} + P A - P Q {q}_{1} )}^{2} - & ( 10 )\end{matrix}$$

$$( {P}^{2} + {Q}^{2} ) ( {Q}^{2} {{p}_{1}}^{2} + {A}^{2} + {Q}^{2} {{q}_{1}}^{2} - 2 {Qq}_{1} A - {Q}^{2} {s}^{2} )$$

The following description will be made by using this discriminant D in a case where two circles have an intersection point (when there are two solutions), a case where the circles have a contact point (when there is one solution), and a case where the circles have no intersection point (when there is no solution).

(i) When Two Circles have an Intersection Point (when there are Two Solutions)

In this case, the condition of the discriminant D is as follows.

$$\begin{matrix}[ Math . 11 ] & \\ D > 0 & ( 11 )\end{matrix}$$

From the expressions (8) and (9), using the formula for the solution of a quadratic expression, the following solution can be obtained.

$$\begin{matrix}[ Math . 12 ] & \\ x = \frac{{Q}^{2} {p}_{1} + PA - {PQq}_{1} \pm \sqrt{{( {Q}^{2} {p}_{1} + PA - {PQq}_{1} )}^{2} - ( {P}^{2} + {Q}^{2} ) ( {Q}^{2} {{p}_{1}}^{2} + {A}^{2} + {Q}^{2} {{q}_{1}}^{2} - 2 {Qq}_{1} A - {Q}^{2} {s}^{2} )}}{{P}^{2} + {Q}^{2}} & ( 12 )\end{matrix}$$

$$y = \frac{{P}^{2} {q}_{1} + Q A - P Q {p}_{1} \pm \sqrt{( {P}^{2} {q}_{1} + {Q A - P Q {p}_{1} )}^{2} - ( {P}^{2} + {Q}^{2} ) ( {P}^{2} {{q}_{1}}^{2} + {A}^{2} + {P}^{2} {{p}_{1}}^{2} - 2 {Pp}_{1} A - {P}^{2} {s}^{2} )}}{{P}^{2} + {Q}^{2}} \qquad ( 13 )$$

(ii) When the Two Circles have a Contact Point (when there is One Solution)

In this case, the condition of the discriminant D is as follows.

$$\begin{matrix}[ Math . 14 ] & \\ D = 0 & ( 14 )\end{matrix}$$

From the expressions (8) and (9), using the formula for the solution of a quadratic expression, the following solution can be obtained.

$$\begin{matrix}[ Math . 15 ] & \\ x = \frac{{Q}^{2} {p}_{1} + P A - P Q {q}_{1}}{{P}^{2} + {Q}^{2}} & ( 15 )\end{matrix}$$

$$y = \frac{{P}^{2} {q}_{1} + Q A - P Q {p}_{1}}{{P}^{2} + {Q}^{2}} \qquad ( 16 )$$

(iii) When the Two Circles have No Intersection Point (when there is No Solution)

In this case, the condition of the discriminant D is as follows.

$$\begin{matrix}[ Math . 17 ] & \\ D < 0 & ( 17 )\end{matrix}$$

When this condition is satisfied, there is no solution satisfying the expressions (8) and (9).

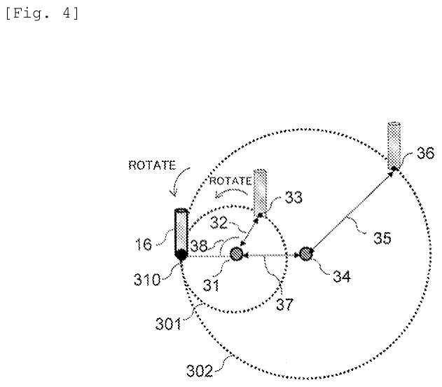

FIG. 4 is a diagram for explaining the calculation of a theoretical measured object center absolute coordinate from two circles having the distance between an origin and an object to be measured as their radii, by extracting the distance to the object to be measured from a point cloud of the object to be measured included in a point cloud obtained from two origins with different distances on an ideal straight line. Here, two pieces of point cloud data having different origin coordinates are used. An origin coordinate 34 is disposed on a linear extension of the object to be measured 16 and an origin coordinate 31 so that the contact point coordinates of the two circles become the center absolute coordinates of the object to be measured 16. First, a measured object center relative coordinate 33 is obtained from the point cloud data acquired with the origin coordinate 31 as the origin. The measured object center relative coordinate 33 is the center coordinate (x_{cp1}, y_{cp1}, z_{cp1}) of the lowermost surface of the object to be measured 16. The measured object center relative coordinate 33 is obtained by creating a three-dimensional model from the point cloud data and extracting the center axis. Here, the object to be measured 16 is assumed to be a utility pole.

Circle information is extracted from the three-dimensional coordinates of the point cloud data, to create a three-dimensional model of the utility pole by connecting circle models in a vertical direction. In order to avoid erroneous detection of a columnar object other than the utility pole, a column length and a diameter are designated in advance. The three-dimensional model matching the designated range is defined as the utility pole to be detected. The center axis is extracted by vertically connecting the center coordinates of the circular model comprising the utility pole model with a three-dimensional approximation curve. The lowest point of the center axis is used as the center coordinate (x_{cp1}, y_{cp1}, z_{cp1}), that is, the measured object center relative coordinate 33. Similarly, a measured object center relative coordinate 36 is obtained from the point cloud data acquired with the origin coordinate 34 as the origin. A distance 32 between the origin coordinate 31 and the object to be measured is calculated from the origin coordinate 31 and the measured object center relative coordinate 33, a circle 301 having a radius of the distance 32 and centered on the origin coordinate 31, and a distance 35 between the origin coordinate 34 and the object to be measured is calculated from the origin coordinate 34 and the measured object center relative coordinate 36, and a measured object center absolute coordinate 310 is uniquely extracted from the intersection point of the two circles. The two circles have different radii, and the intersection point becomes unique by inscribed contact. The circles 301 and 302 are represented by the following expressions, respectively, as in FIG. 3.

$$\begin{matrix}[ Math . 18 ] & \\ {( x - {x}_{1} )}^{2} + {( y - {y}_{1} )}^{2} = {{r}_{1}}^{2} & ( 18 )\end{matrix}$$

$${( x - {x}_{2} )}^{2} + {( y - {y}_{2} )}^{2} = {{r}_{2}}^{2} \qquad ( 19 )$$

Here, the origin coordinate 31 is defined as (x₁, y₁), and the distance 32 is defined as r₁. Similarly, the origin coordinate 34 is defined as (x₂, y₂), and the distance 35 is defined as r₂. Considering that these two expressions are assumed to be simultaneous expressions and have contact points, the following expression can be obtained as in the description of FIG. 3(ii).

$$\begin{matrix}[ Math . 20 ] & \\ X = \frac{{Y}^{2} {x}_{1} + X a - X Y {y}_{1}}{{X}^{2} + {Y}^{2}} & ( 20 )\end{matrix}$$

$$y = \frac{{X}^{2} {y}_{1} + Ya - {XYx}_{1}}{{X}^{2} + {Y}^{2}} \qquad ( 21 )$$

$$X = {x}_{1} - {x}_{2} \qquad ( 22 )$$

$$Y = {y}_{1} - {y}_{2} \qquad ( 23 )$$

$$a = \frac{{{x}_{1}}^{2} - {{x}_{2}}^{2} + {{y}_{1}}^{2} - {{y}_{2}}^{2} - {{r}_{1}}^{2} + {{r}_{2}}^{2}}{2} \qquad ( 24 )$$

A coordinate rotation angle 38(θ) is derived from the contact point coordinate, the origin coordinate 31, and the measured object center relative coordinate 33, and the first point cloud data is subjected to coordinate rotation at the rotation angle, so that the first point cloud data made into absolute coordinates can be obtained. For example, when the center coordinates (x₁, y₁) of the circle 301 are regarded as the origin coordinate (0, 0) and the measured object center relative coordinate (x_{cp1}, y_{cp1}) and the measured object center absolute coordinate 310 (x, y) exist in a first quadrant, the coordinate rotation angle 38(θ) can be derived by the following expression.

$$\begin{matrix}[ Math . 25 ] & \\ {θ}_{1} = t a {n}^{- 1} ( \frac{{y}_{cp 1} - {y}_{1}}{{x}_{cp 1} - {x}_{1}} ) & ( 25 )\end{matrix}$$

$${θ}_{2} = t a {n}^{- 1} ( \frac{y - {y}_{1}}{x - {x}_{1}} ) \qquad ( 26 )$$

$$θ = {θ}_{2} - {θ}_{1} \qquad ( 27 )$$

Here, θ1 is the angle of the measured object center relative coordinate (x_{cp1}, y_{cp1}) viewed from the center coordinate (x₁, y₁) of the circle 301, and 82 is the angle of the measured object center absolute coordinates 310 (x, y) viewed from the center coordinate (x₁, y₁) of the circle 301. The first point cloud data of the relative coordinates are subjected to coordinate rotation by using the derived angle θ, so that the first point cloud data can be converted into absolute coordinates and superimposed on the point cloud data acquired by the MMS. The same applies to the second point cloud data.

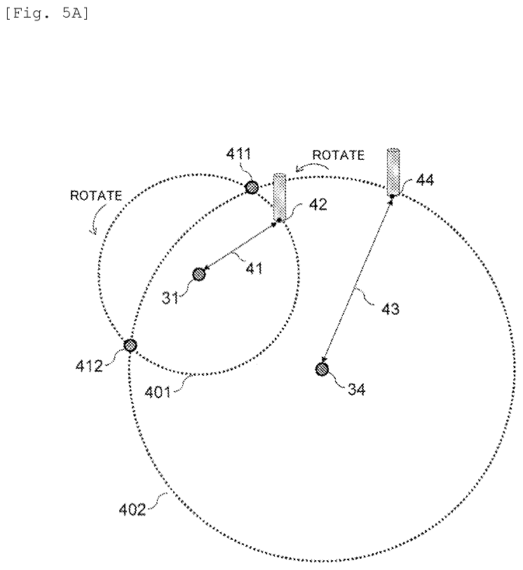

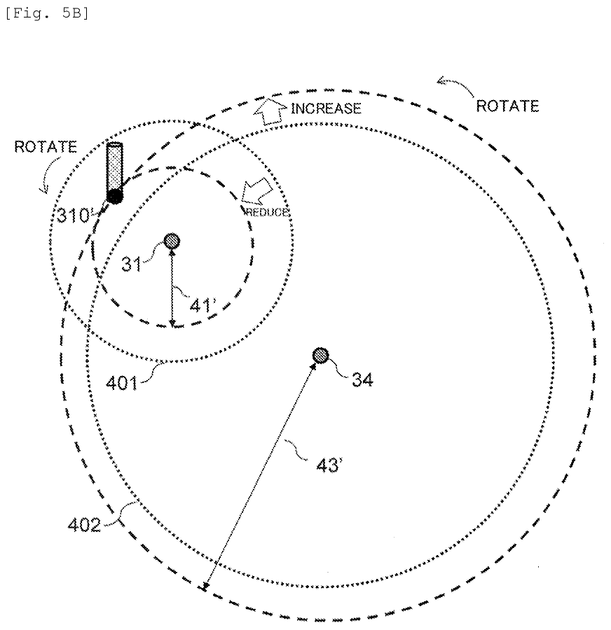

FIG. 5A and FIG. 5B are diagrams for explaining the calculation of a measured object center absolute coordinate 310′ by adjusting the parameter calculated by the measurement to obtain the contact point when two circles 401 and 402 are not inscribed and have two intersections. The circle 401 is a circle centered at the origin coordinate 31 having a distance 41(r₃) as its radius, which is obtained by the radius arithmetic unit calculating the distance 41(r₃) between the origin coordinate 31 and the object to be measured from the origin coordinate 31 and the measured object center relative coordinate 42. The circle 402 is a circle centered at the origin coordinate 34 having a distance 43(r₄) as its radius, which is obtained by calculating the distance 43(r₄) between the origin coordinate 34 and the object to be measured from the origin coordinate 34 and the measured object center relative coordinate 44. The following is a mathematical description of how parameters to be adjusted are specified and adjusted to calculate the measured object center absolute coordinate 310. The intersection points of the two circles are defined as intersection coordinates 411 and 412, respectively. The circles 401 and 402 are represented by the following expressions, respectively, as in FIG. 3.

$$\begin{matrix}[ Math . 28 ] & \\ {( x - {x}_{1} )}^{2} + {( y - {y}_{1} )}^{2} = {{r}_{3}}^{2} & ( 28 )\end{matrix}$$

$${( x - {x}_{2} )}^{2} + {( y - {y}_{2} )}^{2} = {{r}_{4}}^{2} \qquad ( 29 )$$

Here, the origin coordinate 31 is defined as (x₁, y₁), and the distance 41 is defined as r₃. Similarly, the origin coordinate 34 is defined as (x₂, y₂), and the distance 43 is defined as r₄. Considering that these two expressions are assumed to be simultaneous expressions and the two circles have an intersection point, the following expression can be obtained as in the description of FIG. 3(i).

$$\begin{matrix}[ Math . 30 ] & \\ \\ \\ x = \frac{{Y}^{2} {x}_{1} + Xa - {XYy}_{1} \pm \sqrt{{( {Y}^{2} {x}_{1} + Xa - {XYy}_{1} )}^{2} - ( {X}^{2} + {Y}^{2} ) ( {Y}^{2} {{x}_{1}}^{2} + {a}^{2} + {Y}^{2} {{y}_{1}}^{2} - 2 {Yy}_{1} a - {Y}^{2} {{r}_{3}}^{2}}}{{X}^{2} + {Y}^{2}} \\ & ( 30 )\end{matrix}$$

$$y = \frac{{X}^{2} {y}_{1} + Ya - {XYx}_{1} \pm \sqrt{{( {X}^{2} {y}_{1} + Ya - {XYx}_{1} )}^{2} - ( {X}^{2} + {Y}^{2} ) ( {X}^{2} {{y}_{1}}^{2} + {a}^{2} + {X}^{2} {{x}_{1}}^{2} - 2 {Xx}_{1} a - {X}^{2} {{r}_{3}}^{2}}}{{X}^{2} + {Y}^{2}} \qquad ( 31 )$$

$$X = {x}_{1} - {x}_{2} \qquad ( 22 )$$

$$Y = {y}_{1} - {y}_{2} \qquad ( 23 )$$

$$a = \frac{{{x}_{1}}^{2} - {{x}_{2}}^{2} + {{y}_{1}}^{2} - {{y}_{2}}^{2} - {{r}_{3}}^{2} + {{r}_{4}}^{2}}{2} \qquad ( 32 )$$

The intersection coordinates 411 and 412 exist when the conditional expression (11) is satisfied, as described in FIG. 3 (I). In order to accurately derive the center absolute coordinate of the object to be measured, it is desirable to obtain the coordinates from the contact points of the two circles. That is, the problem we want to solve is to specify the value satisfying the condition of [Math. 32] below when the condition of [Math. 1] is satisfied.

$$\begin{matrix}[ Math . 31 ] & \\ D = {( {Y}^{2} {x}_{1} + Xa - {XYy}_{1} )}^{2} - & ( 11 )\end{matrix}$$

$$( {X}^{2} + {Y}^{2} ) ( {Y}^{2} {{x}_{1}}^{2} + {a}^{2} + {Y}^{2} {{y}_{1}}^{2} - 2 {Yy}_{1} a - {Y}^{2} {{r}_{3}}^{2} ) > 0$$

$$D = 0 \qquad ( 14 )$$

[Math. 32]

A specific method is described on the basis of FIG. 5B. This condition is realized by adjusting the values of r₃ and r₄ included in the expressions (30) and (31). For example, at least one of r₃ and r₄ is changed until the two circles 401 and 402 have one contact point, and the contact point of the two circles 401 and 402 is determined. The values of x₁, x₂, y₁, y₂ are acquired from the GNSS surveying instrument, and adjustment is not performed because of higher accuracy compared to the measurement of the distance to the object to be measured. When two intersection points are present in the two circles having a radius of r₃<r₄, D>0 is established. Therefore, the condition of the expression (14) can be realized by reducing r₃ and increasing r₄. The values of r₃ and r₄ can be adjusted to an arbitrary value, enabling the adjustment of only r₃ and only r₄ and simultaneous adjustment of both r₃ and r₄. The following description is made when the values of r₃ and r₄ are changed by the same amount. When the corrected r₃ is denoted as r₃′ (in the diagram, the corrected distance between the origin coordinate 31 and the object to be measured is denoted as the code 41′), and r₄ as r₄′ (in the drawing, the corrected distance between the origin coordinate 34 and the object to be measured is denoted as 43′), the corrected contact point absolute coordinate (measured object center absolute coordinate) 310′ (x′, y′) is expressed by the following expression, as described in FIG. 3(ii).

$$\begin{matrix}[ Math . 33 ] & \\ {x}^{′} = \frac{{Y}^{2} {x}_{1} + {{X}_{a}}^{′} - {XYy}_{1}}{{X}^{2} + {Y}^{2}} & ( 33 )\end{matrix}$$

$${y}^{′} = \frac{{X}^{2} {y}_{1} + {{Y}_{a}}^{′} - XY {x}_{1}}{{X}^{2} + {Y}^{2}} \qquad ( 34 )$$

$$X = {x}_{1} - {x}_{2} \qquad ( 22 )$$

$$Y = {y}_{1} - {y}_{2} \qquad ( 23 )$$

$${a}^{′} = \frac{{{x}_{1}}^{2} - {{x}_{2}}^{2} + {{y}_{1}}^{2} - {{y}_{2}}^{2} - {{{r}_{3}}^{′}}^{2} + {{{r}_{4}}^{′}}^{2}}{2} \qquad ( 35 )$$

In actual calculation, it is not practical to adjust the values of r₃ and r₄ in a stepless manner, and therefore it is necessary to specify a certain width and adjust the values. For example, when the number of digits below the decimal point of the values of the distance 41 between the origin coordinate 31 and the object to be measured and the value of the distance 43 between the origin coordinate 34 and the object to be measured is six digits, the adjustment can be performed in consideration of the effective number by setting 1.0×10⁻⁷ as the adjustment width.

Instead of changing at least one of r₃ and r₄ until the two circles 401 and 402 have one contact point, a middle point obtained by simply averaging two intersection points may be used as the measured object center absolute coordinate 310 after the discriminant D is made to approach the threshold value or less. At this time, it is necessary to adjust the origin coordinate 31 (x₁, y₁) and the origin coordinate 34 (x₂, y₂) so as not to deviate from a straight line passing through the object to be measured 16.

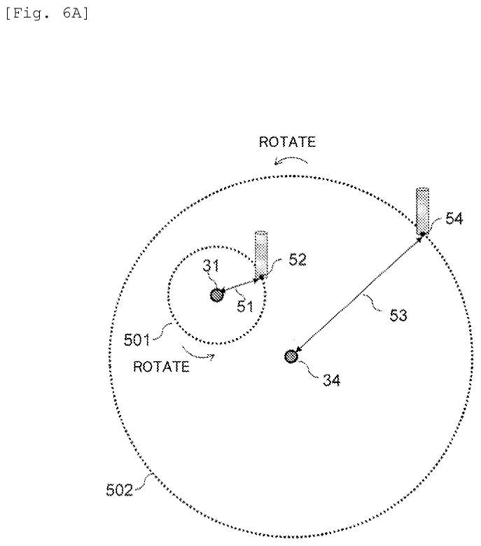

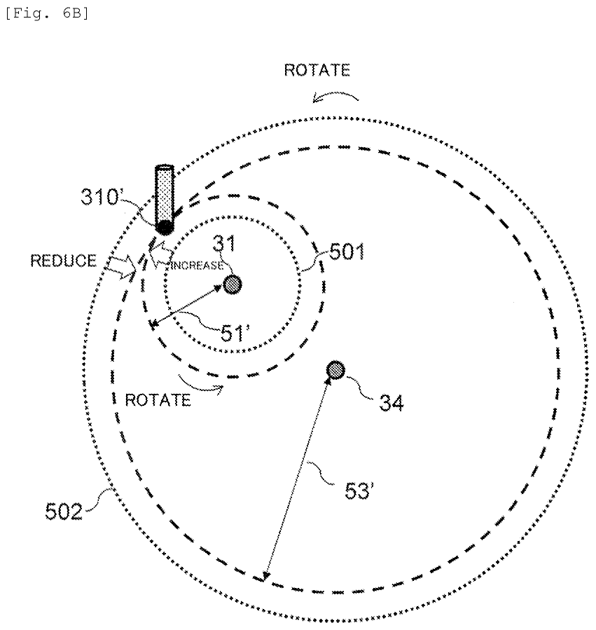

FIGS. 6A and 6B are diagrams for explaining the calculation of the measured object center absolute coordinate 310′ by adjusting the parameter calculated by the measurement to obtain the contact point without having two circles 501 and 502 internally contact each other. The circle 502 is a circle centered at the origin coordinate having a distance 51(r₅) as its radius, which is obtained by the radius arithmetic unit calculating the distance 11(r₅) between the origin coordinate 31 and the object to be measured from the origin coordinate 31 and a measured object center relative coordinate 52. The circle 502 is a circle centered at the origin coordinate 34 having a distance 53(r₆) as its radius, which is obtained by the radius arithmetic unit calculating the distance 53(r₆) between the origin coordinate 34 and the object to be measured from the origin coordinate 34 and a measured object center relative coordinate 54. As in FIGS. 5A and 5B, the following mathematically describes how the measured object center absolute coordinate 310′ can be calculated by specifying and adjusting the parameters to be adjusted. The circles 501 and 502 are represented by the following expressions, respectively, as in FIG. 3.

$$\begin{matrix}[ Math . 36 ] & \\ {( x - {x}_{1} )}^{2} + {( y - {y}_{1} )}^{2} = {{r}_{5}}^{2} & ( 36 )\end{matrix}$$

$${( x - {x}_{2} )}^{2} + {( y - {y}_{2} )}^{2} = {{r}_{6}}^{2} \qquad ( 37 )$$

Here, the origin coordinate 31 is defined as (x₁, y₁), and the distance 51 is defined as r₅. Similarly, the origin coordinate 34 is defined as (x₂, y₂), and the distance 53 is defined as r₆. When there is no contact point, the condition of the discriminant D is as follows, as in the description of FIG. 3 (iii).

$$\begin{matrix}[ Math . 38 ] & \\ D = & ( 38 )\end{matrix}$$

$${( {Y}^{2} {x}_{1} + X a - {XYy}_{1} )}^{2} - ( {X}^{2} + {Y}^{2} ) ( {Y}^{2} {{x}_{1}}^{2} + {a}^{2} + {Y}^{2} {{y}_{1}}^{2} - 2 {Yy}_{1} a - {Y}^{2} {{r}_{5}}^{2} < 0$$

$$X = {x}_{1} - {x}_{2} \qquad ( 22 )$$

$$Y = {y}_{1} - {y}_{2} \qquad ( 23 )$$

$$a = \frac{{{x}_{1}}^{2} - {{x}_{2}}^{2} + {{y}_{1}}^{2} - {{y}_{2}}^{2} - {{r}_{5}}^{2} + {{r}_{6}}^{2}}{2} \qquad ( 39 )$$

In order to accurately derive the center absolute coordinate of the object to be measured, it is desirable to obtain it from a contact point of the two circles. That is, the problem we want to solve is to specify the value satisfying the following [Math. 39] when D<0 (no contact point) is established.

$$\begin{matrix}[ Math . 39 ] & \\ D = 0 & ( 14 )\end{matrix}$$

A specifying method is described on the basis of FIG. 6B. This condition is realized by adjusting the values of r₅ and r₆ included in the expression (38). For example, at least one of r₅ and r₆ is changed until the two circles 501 and 502 have one contact point, and the contact point of the two circles 501 and 502 is determined. When there is no contact point in the two circles having a radius of r₅<r₆, D<0 is established. Therefore, the condition of the expression (14) can be realized by increasing r₅ and reducing r₆. The values of r₅ and r₆ can be adjusted to an arbitrary value, enabling the adjustment of only r₅ and only r₆ and simultaneous adjustment of both r₅ and r₆. The following description is made when the values of r₅ and r₆ are changed by the same amount. If r₅ is defined as r₅′ (corrected distance 51′ between the origin coordinate 31 and the object to be measured) and r₆ is defined as r₆′ (corrected distance 53′ between the origin coordinate 34 and the object to be measured), the corrected contact point absolute coordinate (measured object center absolute coordinate) 310′ (x′, y′) is expressed by the following expression.

$$\begin{matrix}[ Math . 40 ] & \\ {x}^{′} = \frac{{Y}^{2} {x}_{1} + {Xa}^{′} - {XYy}_{1}}{{X}^{2} + {Y}^{2}} & ( 40 )\end{matrix}$$

$${y}^{′} = \frac{{X}^{2} {y}_{1} + {Ya}^{′} - {XYx}_{1}}{{X}^{2} + {Y}^{2}} \qquad ( 41 )$$

$$X = {x}_{1} - {x}_{2} \qquad ( 22 )$$

$$Y = {y}_{1} - {y}_{2} \qquad ( 23 )$$

$${a}^{′} = \frac{{{x}_{1}}^{2} - {{x}_{2}}^{2} + {{y}_{1}}^{2} - {{y}_{2}}^{2} - {{r}_{{5}^{′}}}^{2} + {{r}_{{6}^{′}}}^{2}}{2} . \qquad ( 42 )$$

In actual calculation, it is not practical to adjust the values of r₅ and r₆ in a stepless manner, and therefore it is necessary to specify a certain width and adjust the values. For example, when the number of digits below the decimal point of the values of the distance 51 between the origin coordinate 31 and the object to be measured and the value of the distance 53 between the origin coordinate 34 and the object to be measured is six digits, the adjustment can be performed in consideration of the effective number by setting 1.0×10⁻⁷ as the adjustment width.

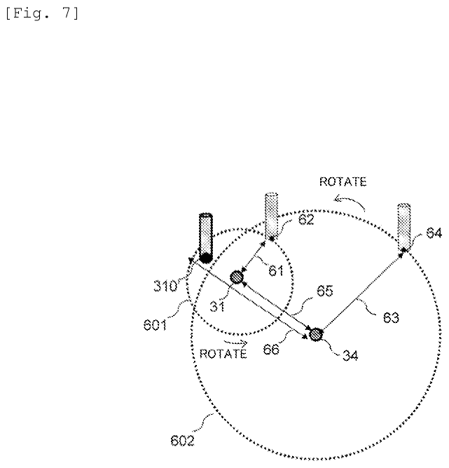

FIG. 7 is a diagram for explaining the calculation where the radii of two circles are adjusted to obtain the measured object center absolute coordinate 310′ as a unique point, when the two circles are not inscribed and do not intersect or have a contact point, by comparing the value of a distance 66, which is the sum of a distance 61 (r₇) between the origin coordinate 31 and the object to be measured obtained from the origin coordinate 31 and a measured object center relative coordinate 62 and a distance 65 between the origin coordinate 31 and the origin coordinate 34, with the value of a distance 63 (r₈) between the origin coordinate 34 and the object to be measured obtained from the origin coordinate a measured object center relative coordinate 64. The two circles are a circle 601 having the origin coordinate 31 as a center and the distance 61 (r₇) between the origin coordinate 31 and the object to be measured as its radius, and a circle 602 having the origin coordinate 34 as a center coordinate and the distance 63 (r₈) between the origin coordinate 34 and the object to be measured as its radius. Here, the expressions of the two circles are expressed by the following expressions, respectively, as in the description of FIG. 3.

$$\begin{matrix}[ Math . 43 ] & \\ {( x - {x}_{1} )}^{2} + {( y - {y}_{1} )}^{2} = {{r}_{7}}^{2} & ( 43 )\end{matrix}$$

$${( x - {x}_{2} )}^{2} + {( y - {y}_{2} )}^{2} = {{r}_{8}}^{2} \qquad ( 44 )$$

Therefore, if r₈>r₇, the distance 66 is expressed by the following expression.

$$\begin{matrix}[ Math . 45 ] & \\ Distance 66 = {r}_{7} + \sqrt{{( {x}_{1} - {x}_{2} )}^{2} + {( {y}_{1} - {y}_{2} )}^{2}} & ( 45 )\end{matrix}$$

When the two circles having a radius of r₇<r₈ are inscribed, the following conditions are satisfied between the distance 66 and the distance 63.

$$\begin{matrix}[ Math . 46 ] & \\ {r}_{7} + \sqrt{{( {x}_{1} - {x}_{2} )}^{2} + {( {y}_{1} - {y}_{2} )}^{2}} = {r}_{8} & ( 46 )\end{matrix}$$

In order to accurately derive the center absolute coordinate of the object to be measured, it is desirable to obtain it from a contact point of the two circles. That is, this is when a conditional expression (46) is established. A method of deriving a radius satisfying the conditional expression (46) is described in two cases, that is, a case where the circles have an intersection point and a case where the circles do not have a contact point.

(i) When the Circles have an Intersection Point

When the two circles having a radius of r₇<r₈ have an intersection point, the following conditions are satisfied.

$$\begin{matrix}[ Math . 47 ] & \\ {r}_{7} + \sqrt{{( {x}_{1} - {x}_{2} )}^{2} + {( {y}_{1} - {y}_{2} )}^{2}} > {r}_{8} & ( 47 )\end{matrix}$$

Therefore, by reducing r₇ which is the distance 61 between the origin coordinate 31 and the object to be measured and increasing r₈ which is the distance 63 between the origin coordinate 34 and the object to be measured, the two circles are inscribed. The values of r₇ and r₈ can be adjusted to an arbitrary value, enabling adjustment of only r₇ and only r₈ and simultaneous adjustment of both r₇ and r₈.

(ii) When the Circles have No Contact Point

When the two circles having a radius of r₇<r₈ have no contact point, the following conditions are satisfied.

$$\begin{matrix}[ Math . 48 ] & \\ {r}_{7} + \sqrt{{( {x}_{1} - {x}_{2} )}^{2} + {( {y}_{1} - {y}_{2} )}^{2}} < {r}_{8} & ( 48 )\end{matrix}$$

Therefore, by increasing r₇ which is the distance 61 between the origin coordinate 31 and the object to be measured and reducing r₈ which is the distance 63 between the origin coordinate 34 and the object to be measured, the two circles are inscribed. The values of r₇ and r₈ can be adjusted to an arbitrary value, enabling adjustment of only r₇ and only r₈ and simultaneous adjustment of both r₇ and r₈.

Since it is not realistic to realize the conditional expression (46) in the actual calculation, in the case of the condition (i), a threshold value is provided, and after the value of the distance 66 and the value of the distance 63 are brought close to the threshold value or less, a middle point obtained by simply averaging the intersection points is taken as the measured object center absolute coordinate 310′. In the case of the condition (ii), it is necessary to perform the same processing as (i) after the r₇ and r₈ are adjusted to the condition where the circles have an intersection point.

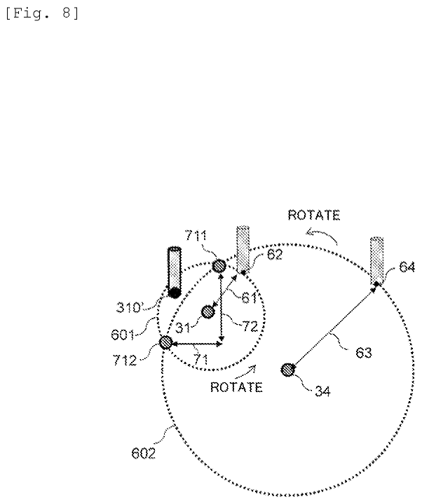

FIG. 8 is a diagram for explaining the calculation where the radii of two circles are adjusted to obtain the measured object center absolute coordinate 310′ as a unique point when the two circles are not inscribed and have an intersection point, from a distance 71 between the x coordinates of an intersection point coordinate 711 (x₇′, y₇′) and an intersection point coordinate 712 (x₇″, y₇″). The two circles are circles 601 and 602 shown in FIG. 7. When the two circles are inscribed, the following conditions are satisfied for the distance 71 and the distance 72.

$$\begin{matrix}[ Math . 49 ] & \\ \vert {{x}_{7}}^{′} - {{{x}_{7}}^{′}}^{′} \vert = 0 and \vert {{y}_{7}}^{′} - {{{y}_{7}}^{′}}^{′} \vert = 0 & ( 49 )\end{matrix}$$

The x-coordinates and y-coordinates of the intersection points are expressed by the following expressions as in FIG. 3(i).

$$\begin{matrix}[ Math . 50 ] & \\ x = \frac{( {Y}^{2} {x}_{1} + Xa - {XYy}_{1} \pm \sqrt{{( {Y}^{2} {x}_{1} + Xa - {XYy}_{1} )}^{2} - ( {X}^{2} + {Y}^{2} ) ( {Y}^{2} {{x}_{1}}^{2} + {a}^{2} + {Y}^{2} {{y}_{1}}^{2} - 2 {Yy}_{1} a - {Y}^{2} {{r}_{7}}^{2} )}}{{X}^{2} + {Y}^{2}} & ( 50 )\end{matrix}$$

$$y = \frac{( {X}^{2} {y}_{1} + Ya - XY {x}_{1} \pm \sqrt{{( {X}^{2} {y}_{1} + Y a - X Y {x}_{1} )}^{2} - ( {X}^{2} + {Y}^{2} ) ( {X}^{2} {{y}_{1}}^{2} + {a}^{2} + {X}^{2} {{x}_{1}}^{2} - 2 {Xx}_{1} a - {X}^{2} {{r}_{7}}^{2} )}}{{X}^{2} + {Y}^{2}} \qquad ( 51 )$$

$$X = {x}_{1} - {x}_{2} \qquad ( 22 )$$

$$Y = {y}_{1} - {y}_{2} \qquad ( 23 )$$

$$a = \frac{{{x}_{1}}^{2} - {{x}_{2}}^{2} + {{y}_{1}}^{2} - {{y}_{2}}^{2} - {{r}_{7}}^{2} + {{r}_{8}}^{2}}{2} \qquad ( 52 )$$

In order to accurately derive the center absolute coordinate of the object to be measured, it is desirable to obtain it from a contact point of the two circles. That is, this is when a conditional expression (49) is satisfied. However, based on the description of FIG. 3, when the condition of the discriminant D that can be derived from simultaneous expressions of the two circles is used, the derivation is performed when the following condition is satisfied.

$$\begin{matrix}[ Math . 53 ] & \\ D = {( {Y}^{2} {x}_{1} + Xa - {XYy}_{1} )}^{2} - & ( 53 )\end{matrix}$$

$$( {X}^{2} + {Y}^{2} ) ( {Y}^{2} {{x}_{1}}^{2} + {a}^{2} + {Y}^{2} {{y}_{1}}^{2} - 2 {Yy}_{1} a - {Y}^{2} {{r}_{7}}^{2} ) = 0$$

$$X = {x}_{1} - {x}_{2} \qquad ( 22 )$$

$$Y = {y}_{1} - {y}_{2} \qquad ( 23 )$$

$$a = \frac{{{x}_{1}}^{2} - {{x}_{2}}^{2} + {{y}_{1}}^{2} - {{y}_{2}}^{2} - {{r}_{7}}^{2} + {{r}_{8}}^{2}}{2} \qquad ( 52 )$$

Similar to FIG. 7, a method of deriving a radius satisfying the conditional expression (49) will be described for two cases, i.e., a case where the circles have an intersection point and a case where the circles do not have a contact point.

(i) When the Circles have an Intersection Point

When the two circles having a radius of r₇<r₈ have an intersection point, the condition of the discriminant D shown by an expression (53) is as follows, as in the description of FIG. 3(i).

$$\begin{matrix}[ Math . 54 ] & \\ D > 0 & ( 54 )\end{matrix}$$

When r₇ that is the distance 61 between the origin coordinate 31 and the object to be measured is reduced, r₈ that is the distance 63 between the origin coordinate 34 and the object to be measured is increased, and the conditional expression (49) is satisfied, the two circles are inscribed. The values of r₇ and r₈ can be adjusted to an arbitrary value, enabling the adjustment of only r₇ and only r₈ and simultaneous adjustment of both r₇ and r₈.

(ii) When the Circles have No Contact Point

When the two circles having a radius of r₇<r₈ have no contact point, the condition of the discriminant D shown by the expression (53) is as follows, as in the description of FIG. 3 (iii).

$$\begin{matrix}[ Math . 55 ] & \\ D < 0 & ( 55 )\end{matrix}$$

When r₇ that is the distance 61 between the origin coordinate 31 and the object to be measured is increased, r₈ that is the distance 63 between the origin coordinate 34 and the object to be measured is reduced, and the conditional expression (49) is satisfied, the two circles are inscribed. The values of r₇ and r₈ can be adjusted to an arbitrary value, enabling the adjustment of only r₇ and only r₈ and simultaneous adjustment of both r₇ and r₈.

Since it is not realistic to realize the conditional expression (49) in the actual calculation, in the case of the condition (i), a threshold value is provided, and after the distance 71 which is the x-coordinate difference of the intersection point and the distance 72 which is the y-coordinate distance are brought close to the threshold value or less, a middle point obtained by simply averaging the intersection point coordinates 711 and 712 is taken as the measured object center absolute coordinate 310′. In the case of the condition (ii), it is necessary to perform the same processing as (i) after the r₇ and r₈ are adjusted to the condition where the circles have an intersection point.

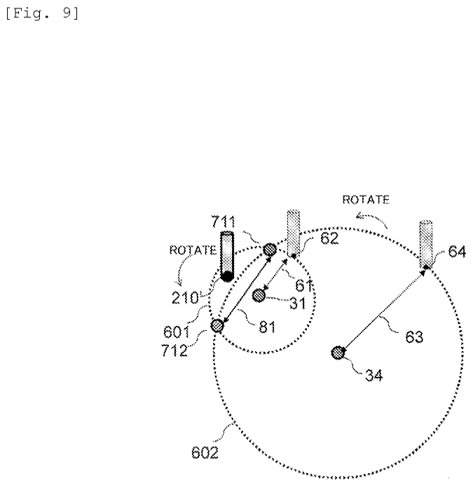

FIG. 9 is a diagram for explaining the calculation where the radii of two circles are adjusted to obtain the measured object center absolute coordinate 310′ as a unique point when the two circles are not inscribed and have an intersection point, from a distance 81 between the intersection point coordinate 711 (x₇, y₇) and the intersection point coordinate 712 (x₇″, y₇″). The two circles are circles 601 and 602 shown in FIG. 7. When the two circles are inscribed, the following conditions are satisfied for the distance 81.

$$\begin{matrix}[ Math . 56 ] & \\ \sqrt{{( {{x}_{7}}^{′} - {{{x}_{7}}^{′}}^{′} )}^{2} + {( {{y}_{7}}^{′} - {{{y}_{7}}^{′}}^{′} )}^{2}} = 0 & ( 56 )\end{matrix}$$

The x-coordinate and the y-coordinate of the intersection point are represented by five expressions (22), (23), (50), (51), Nd (52). In order to accurately derive the center absolute coordinate of the object to be measured, it is desirable to obtain it from a contact point of the two circles. That is, this is when a conditional expression (56) is established. However, based on the description of FIG. 3, as in FIG. 8, the derivation is performed when the conditional expression (53) of the discriminant D that can be derived from simultaneous expressions of the two circles is established. As in FIG. 8, when the circles have an intersection point, a method for deriving a radius satisfying the conditional expression (56) is described for two cases, that is, a case where the circles have an intersection point and a case where the circles do not have a contact point.

(i) When the Circles have an Intersection Point

When the two circles having a radius of r₇<r₈ have an intersection point, the condition of the discriminant D shown by an expression (50) is as follows, as in the description of FIG. 3(i).

$$\begin{matrix}[ Math . 57 ] & \\ D > 0 & ( 57 )\end{matrix}$$

When r₇ that is the distance 61 between the origin coordinate 31 and the object to be measured is reduced, r₈ that is the distance 63 between the origin coordinate 34 and the object to be measured is increased, and the conditional expression (56) is satisfied, the two circles are inscribed. The values of r₇ and r₈ can be adjusted to an arbitrary value, enabling the adjustment of only r₇ and only r₈ and simultaneous adjustment of both r₇ and r₈.

(ii) When the Circles have No Contact Point

When the two circles having a radius of r₇<r₈ have no contact point, the condition of the discriminant D shown by the expression (53) is as follows, as in the description of FIG. 3 (iii).

$$\begin{matrix}[ Math . 58 ] & \\ D < 0 & ( 58 )\end{matrix}$$

When r₇ that is the distance 61 between the origin coordinate 31 and the object to be measured is increased, r₈ that is the distance 63 between the origin coordinate 34 and the object to be measured is reduced, and the conditional expression (56) is satisfied, the two circles are inscribed. The values of r₇ and r₈ can be adjusted to an arbitrary value, enabling the adjustment of only r₇ and only r₈ and simultaneous adjustment of both r₇ and r₈.

Since it is not realistic to realize the conditional expression (56) in the actual calculation, in the case of the condition (i), a threshold is provided for the distance 81 between two intersection points, and after the distance 81 is brought close to 0 within the threshold value, a middle point obtained by simply averaging the intersection point coordinates 711 and 712 is taken as the measured object center absolute coordinate 310′. In the case of the condition (ii), it is necessary to perform the same processing as (i) after the r₇ and r₈ are adjusted to the condition where the circles have an intersection point.

### Effect of Present Disclosure

It is considered that the coordinate conversion device, coordinate conversion method, and coordinate conversion program for a three-dimensional point cloud according to the present disclosure have the following advantages to the invention described in the prior application.

In the invention described in the previous application, the two circles whose radii are the origin absolute coordinate of the fixed three-dimensional laser scanner at two points and the distance from the origin coordinates at two points to the object to be measured are inscribed and the contact point is theoretically one, but in reality, due to errors in distance measurement, the two intersection points exist or there is no contact point, affecting the coordinate accuracy when the point cloud of relative coordinates acquired with the fixed three-dimensional laser scanner is converted to absolute coordinates. On the other hand, in the present disclosure, the point cloud of relative coordinates can be automatically and accurately converted into absolute coordinates by performing arithmetic processing in two cases, i.e., a case where two intersection points exist and a case where no contact point exists. Furthermore, by conversion into absolute coordinates, it is possible to correctly superimpose data on data of absolute coordinates acquired by the MMS or the like, and to display position information on a three-dimensional space.

### INDUSTRIAL APPLICABILITY

The present disclosure is applicable to information and communication industries.

### REFERENCE SIGNS LIST

11: Three-dimensional laser scanner
12, 12′: Relative coordinate origin of three-dimensional
laser scanner
13, 13′: GNSS surveying instrument
14, 14′: Absolute coordinate origin of three-dimensional
laser scanner
15,: First measurement position
15′: Second measurement position
16: Object to be measured
17: Relative center coordinate of object to be measured
18: Absolute center coordinate of object to be measured
100: Coordinate conversion device
111, 112: Storage unit
113: Arithmetic processing unit

1. A three-dimensional point cloud coordinate conversion device, configured to:
acquire first point cloud data in which an object to be measured existing in a three-dimensional space is represented by a point cloud of relative coordinates centered at a predetermined first origin, and absolute coordinates of the first origin, convert coordinates of the first point cloud data into relative coordinates having the absolute coordinates of the first origin as an origin;
acquire second point cloud data represented by a point cloud of relative coordinates centered at a second origin located on a straight line connecting the object to be measured and the first origin, and absolute coordinates of the second origin, convert coordinates of the second point cloud data into relative coordinates having the absolute coordinates of the second origin as an origin;
specify a first reference point of the object to be measured in relative coordinates having absolute coordinates of the first origin as an origin, by using the first point cloud data;
specify a second reference point of the object to be measured in relative coordinates having absolute coordinates of the second origin as an origin, by using the second point cloud data;
calculate a first distance between the first origin and the first reference point and a second distance between the second origin and the second reference point;
specify a contact point between a first circle having the first origin as a center and the first distance as a radius and a second circle having the second origin as a center and the second distance as a radius, by changing at least one of the first and second distances; and
specify a rotation angle for converting the first or second point cloud data into absolute coordinates on the basis of the contact point, the first origin or the second origin, and the first or second reference point, rotate the first point cloud data or the second point cloud data, and convert the first point cloud data or the second point cloud data into a point cloud of absolute coordinates.

2. The three-dimensional point cloud coordinate conversion device according to claim 1, wherein when specifying a contact point between the first circle and the second circle, at least one of the first and second distances is changed until a distance between two intersection points of the first circle and the second circle falls within a predetermined threshold.

3. The three-dimensional point cloud coordinate conversion device according to claim 1, wherein when specifying a contact point between the first circle and the second circle, if the first circle and the second circle have two intersection points, a larger one of the first and the second distances is increased, or a smaller one of the first and the second distances is reduced, or both of the increasing and the reducing are executed.

4. The three-dimensional point cloud coordinate conversion device according to claim 1, wherein when specifying a contact point between the first circle and the second circle, if the first circle and the second circle do not have a contact point, a larger one of the first and the second distances is reduced, or a smaller one of the first and the second distances is increased, or both of the reducing and the increasing are executed.

5. The three-dimensional point cloud coordinate conversion device according to any one of claim 1, wherein the object to be measured is a utility pole used in a communication system, and
the first reference point and the second reference point of the object to be measured are specified by using a three-dimensional model of the utility pole created from the point cloud data.

6. A three-dimensional point cloud coordinate conversion device, configured to:
acquire first point cloud data in which an object to be measured existing in a three-dimensional space is represented by a point cloud of relative coordinates centered at a predetermined first origin, and absolute coordinates of the first origin, convert coordinates of the first point cloud data into relative coordinates having the absolute coordinates of the first origin as an origin;
acquiring second point cloud data represented by a point cloud of relative coordinates centered at a second origin located on a straight line connecting the object to be measured and the first origin, and absolute coordinates of the second origin, converting coordinates of the second point cloud data into relative coordinates having the absolute coordinates of the second origin as an origin;
specifying a first reference point of the object to be measured in relative coordinates having absolute coordinates of the first origin as an origin, by using the first point cloud data;
specifying a second reference point of the object to be measured in relative coordinates having absolute coordinates of the second origin as an origin, by using the second point cloud data;
calculating a first distance between the first origin and the first reference point and a second distance between the second origin and the second reference point;
specifying a contact point between a first circle having the first origin as a center and the first distance as a radius and a second circle having the second origin as a center and the second distance as a radius, by changing at least one of the first and second distances; and
specifying a rotation angle for converting the first or second point cloud data into absolute coordinates on the basis of the contact point, the first origin or the second origin, and the first or second reference point, rotating the first point cloud data or the second point cloud data, and converting the first point cloud data or the second point cloud data into a point cloud of absolute coordinates.

7. A non-transitory computer-readable medium having computer-executable instructions that, upon execution of the instructions by a processor of a computer, cause the computer to function as in the three-dimensional point cloud coordinate conversion device according to claim 1.
